(19) United States
(12) Patent Application Publication
(10) Pub. No.: US 2014/0359448 A1
(43) Pub. Date: Dec. 4, 2014

(54) ADDING CAPTIONS AND EMPHASIS TO VIDEO

(71) Applicant: MICROSOFT CORPORATION, REDMOND, WA (US)

(72) Inventors: OWEN W. PAULUS, KIRKLAND, WA (US); ARWA TYEBKHAN, REDMOND, WA (US); PRASHANTH L. KAMATH, REDMOND, WA (US); BENJAMIN L. PERRY, REDMOND, WA (US); ANDREW SHAUN IVORY, WOODINVILLE, WA (US)

(21) Appl. No.: 13/906,365

(22) Filed: May 31, 2013

(51) Int. Cl. G06F 3/0484; G06F 3/0488

(52) U.S. Cl. CPC G06F 3/04847; G06F 3/0488
USPC 715/722

(57) ABSTRACT

In one embodiment, a digital video device may allow for real time editing of a digital video data clip during viewing. A digital video viewer 200 may display a digital video clip to a user in a standard viewing mode. The digital video viewer 200 may receive a frame selection from a user. The digital video viewer 200 may automatically add an emphasis effect to the frame selection.

### BACKGROUND

Smart phones and tablet computers may have a digital video camera for digitally capturing different life events of a user, such as weddings, children's activities, and other personal moments. The user may then view the recorded digital video on a display screen on the recording device. The user may then send the digital video to friends and family, via e-mail, text messaging, or other messaging methods. Alternately, the user may post the digital video to an online forum, video service, or social network. The digital video clip may be a series of video frames progressively shown to create the illusion of motion. A video frame is a static digital image, representing a point in time of the digital video clip.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to real time editing of a digital video data clip during viewing. A digital video viewer may display a digital video clip to a user in a standard viewing mode. The digital video viewer may receive a frame selection from a user. The digital video viewer may automatically add an emphasis effect to the frame selection.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a digital video viewer user interface.

FIGS. 3a-d illustrates, in block diagrams, embodiments of a user interface interaction with sectional edits of a digital video clip.

FIG. 4 illustrates, in a block diagram, one embodiment of a video frame input screen.

FIG. 5 illustrates, in a block diagram, one embodiment of an animated video frame.

FIG. 6 illustrates, in a flowchart, one embodiment of a method for receiving editing commands for a digital video clip.

FIG. 7 illustrates, in a flowchart, one embodiment of a method for editing a section of a digital video clip.

FIG. 8 illustrates, in a flowchart, one embodiment of a method for adding an audio effect to a digital video clip.

FIG. 9 illustrates, in a flowchart, one embodiment of a method for adding a caption to a digital video clip.

FIG. 10 illustrates, in a flowchart, one embodiment of a method for adding an emphasis effect to a frame selection.

FIG. 11 illustrates, in a flowchart, one embodiment of a method for adding a caption to a frame selection.

FIG. 12 illustrates, in a flowchart, one embodiment of a method for adding a video effect to a frame selection.

FIG. 13 illustrates, in a flowchart, one embodiment of a method for adding a frame region highlight.

FIG. 14 illustrates, in a flowchart, one embodiment of a method for frame region selection.

FIG. 15 illustrates, in a flowchart, one embodiment of a method for captioning.

FIG. 16 illustrates, in a flowchart, one embodiment of a method for vectoring.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a digital video device.

A digital video device may execute a digital video viewer. A digital video viewer is an application that presents a digital video clip to a user for viewing. Additionally, a digital video viewer may also allow a user to edit the digital video clip in real time while viewing the digital video clip in standard viewing mode. In the past, such editing was generally done in an edit mode or with a separate editing application. The user may edit a digital video clip to draw attention to specific video frames or sections of video frames in a digital video clip.

The user may edit a digital video clip by directly manipulating a scrub bar. The scrub bar is a linear representation of the timeline of a digital video clip. The user may execute a trim action by dragging the start or end of the digital video clip to indicate that the beginning or end of the digital video clip may be moved. The user may execute a move action by dragging a section selection, changing the beginning and end point of a section of the digital video clip while keeping the duration the same. For example, the user may select the second minute of a digital video clip, and then change the selection to the fourth minute of the digital video clip. Further, the digital video clip may be split into multiple segments based on a user gesture, with each segment capable of being independently manipulated. A split segment may be divided to excise a section in the middle of the digital video clip. The sections of the scrub bar may be color-coded to indicate which sections are to be considered an active part of the digital video clip and which sections are inactive.

The user may use a play head of the scrub bar to identify clip edit points to edit a digital video clip. The play-head may travel along the scrub bar, representing the specific moment in the digital video clip being displayed. A clip editor control may be tethered to the play-head, allowing users to edit the digital video clip at the location of the play head. The digital video viewer may provide a quick preview of the edits applied to the video frame using a preview thumbnail.

The digital video viewer may make one or more edits, such as adding an emphasis effects, starting at one or more frame selections in the digital video clip. An emphasis effect may be a video effect, a caption effect, or an audio effect. The video effect may be a tint setting change, a time setting change, or a freeze frame. Additionally, a user may enter a caption and emphasize words in the caption to enhance meaning and visual presentation in the final output. The digital video viewer may also provide visual feedback about the impact of emphasizing words in the caption through this preview thumbnail. The digital video viewer may automatically select words for emphasis, or allow the user to select the words. The digital video editor may convert the words into individual touch targets that toggle on and off based on user selection. Toggling a word on may emphasize the word, while toggling a word off may de-emphasize the word.

The digital video viewer may add one or more video animations to highlight one or more frame regions within a selected video frame. The user may indicate the direction to move the video animation in successive frames. The digital video viewer may contrast the video tint of a frame region as compared to the rest of the video frame.

Thus, in one embodiment, a digital video device may allow for real time editing of a digital video data clip during viewing. A digital video viewer may display a digital video clip to a user in a standard viewing mode. The digital video viewer may overlay a scrub bar over the digital video clip to receive a user input. The digital video viewer may move between a predecessor video frame and a successor video frame of the digital video clip by moving a play head in the scrub bar. The digital video viewer may tether a clip editor control to the play head to edit the digital video clip. The digital video viewer may receive a frame selection from a user. The digital video viewer may automatically add an emphasis effect to the frame selection. A digital video viewer may present a video frame of a digital video clip based on a user frame selection. The digital video viewer may receive a user input to the video frame indicating a frame region. The digital video viewer may automatically add a video animation to the digital video clip to highlight the frame region.

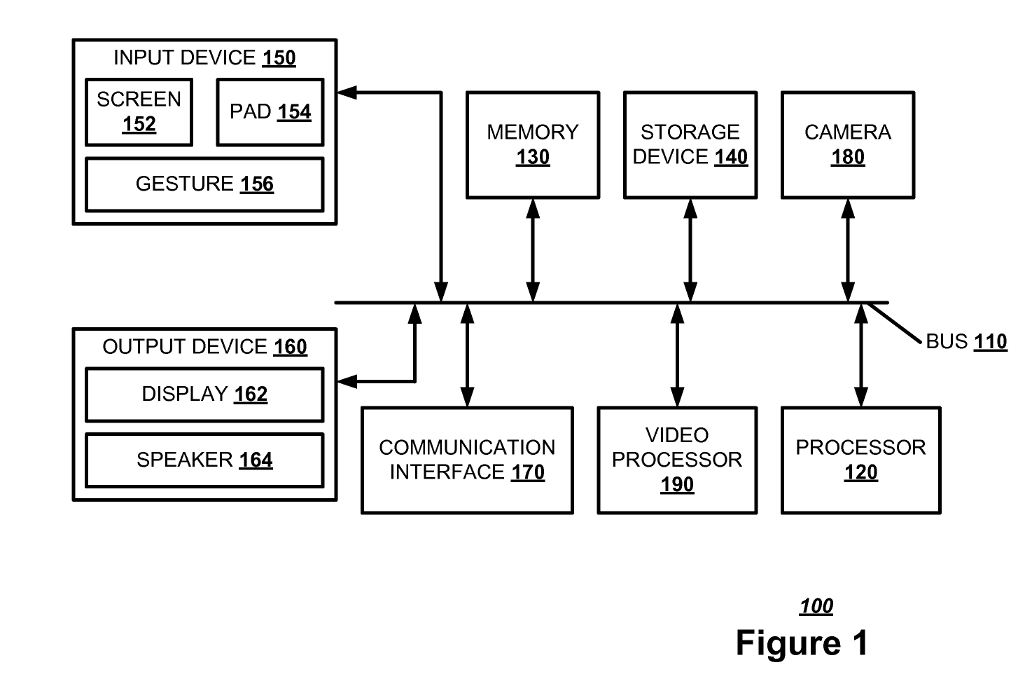

FIG. 1 illustrates a block diagram of an exemplary computing device 100 which may act as a digital video device. The computing device 100 may combine one or more of hardware, software, firmware, and system-on-a-chip technology to implement a digital video device. The computing device 100 may include a bus 110, a processor 120, a memory 130, a data storage 140, an input device 150, an output device 160, and a communication interface 170. For video intensive activities, the computing device 100 may additionally have a digital video camera 180 and a video processor 190. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method. The data storage 140 may also be a database or a database interface for storing digital video clips.

The input device 150 may include one or more conventional mechanisms that permit a user to input information to the computing device 100, such as a keyboard, a mouse, a voice recognition device, a microphone, a headset, a touch screen 152, a touch pad 154, a gesture recognition device 156, etc. The output device 160 may include one or more conventional mechanisms that output information to the user, including a display 162, a printer, one or more speakers 164, a headset, or a medium, such as a memory, or a magnetic or optical disk and a corresponding disk drive. The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The digital video camera 180 may capture digital video clips to be stored in the storage device 140. The video processor 190 may process the digital video clip to improve the quality. The video processor 190 may stabilize the video, removing jitter caused by hand movement during filming. The video processor 190 may also process the digital video clip to clarify the digital frames in the digital video clip.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 170.

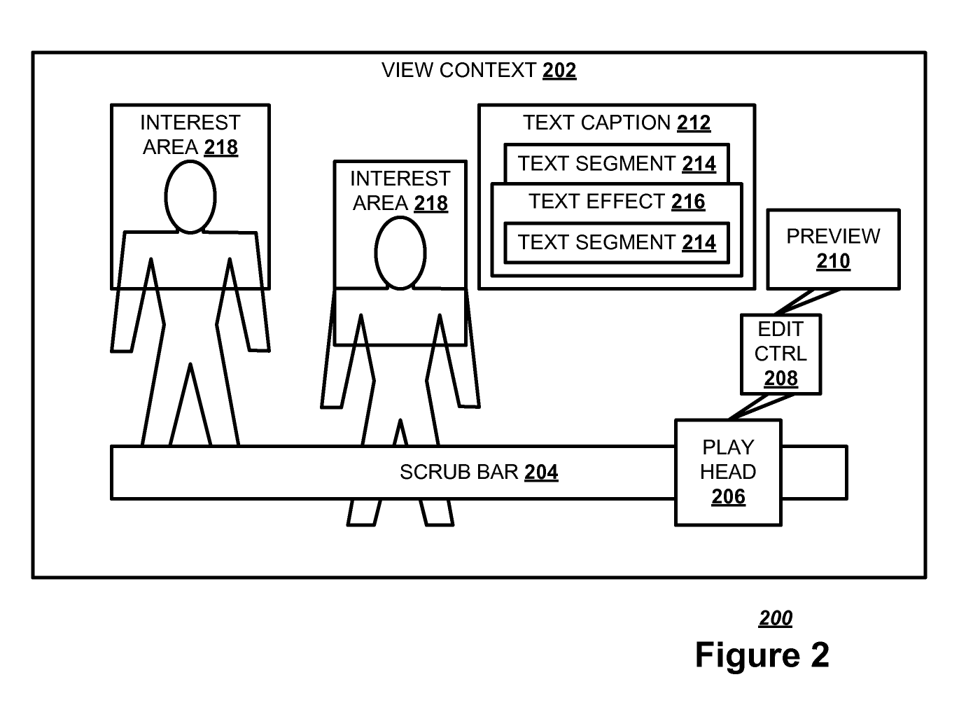

FIG. 2 illustrates, in a block diagram, one embodiment of a user interface for a digital video viewer 200. The digital video viewer 200 may have a view context 202 displaying a digital video clip while in a standard viewing mode. The digital video clip may be displayed by the same digital video device that captured the digital video clip or downloaded by a different digital video device from an external data storage. The digital video viewer 200 may have a scrub bar 204 that tracks the progression of the digital video clip from an initial video frame to a final video frame. The scrub bar 204 may have a play head 206 that moves along the scrub bar 204 to indicate the progression of the digital video clip. A user may select the play head 206 and move the play head 206 along the scrub bar 204 to make a frame selection for a clip edit point in the digital video clip to display.

The digital video viewer 200 may tether a clip editor control 208 to the play head 206, so that the clip editor control 208 moves with the play head 206. The clip editor control 208 edits the digital video clip at the frame selected as a clip edit point by the play head 206. By tethering the clip editor control 208 to the play head 206, the digital video viewer 200 may allow editing of the digital video clip while in the standard viewing mode, rather than having to enter an editing mode. The clip editor control 208 may add an emphasis effect to the frame selection to draw the attention of the viewer to that frame selection. The user may use the clip editor control 208 to add a video animation to highlight a frame region of the video frame.

The digital video viewer 200 may display a thumbnail preview 210 of the frame selection tethered to the clip editor control 208 or the play head 206. The thumbnail preview 210 may show the unedited frame selection. After an emphasis effect has been added, the thumbnail preview 210 may preview the look of the frame selection with the emphasis effect.

The emphasis effect may be a video effect, sound effect, caption 212, or other effect that enhances the frame selection. A video effect is a change to the visual composition of the frame selection to draw attention to the frame selection. The video effect may apply to a set number of frames after the frame selection, determined either by the number of frames or by a set fraction of the digital video clip run time. The video effect may be changing the tint setting of the frame selection, such as changing a color frame selection to black and white or sepia tone. The video effect may be applying a freeze frame, extending the display of the same frame selection for a set fraction of the digital video clip run time. The video effect may be altering a time setting of the frame selection, causing the transition between frames to occur more slowly or more quickly. The video effect may be selected by the user, or may be automatically chosen based on a pre-set visual theme, such as movie noir or movie romance.

An audio effect is a change to the audio accompanying a frame selection to draw attention to the frame selection. The audio effect may be adding a soundtrack audio from the point of the frame selection onward. The audio effect may be muting the clip audio from the digital video clip. The audio effect may continue for the rest of the digital video clip run time, the rest of the soundtrack run time, or a different period of time.

A caption 212 is a string of one or more letters, numbers, or communicative symbols, such as emoticons, overlaid on the frame selection. The digital video viewer 200 may show the caption 212 over video frames successive to the frame selection for a caption display time. The caption display time may be based on the amount of time an average reader takes to read the caption 212, referred to as a caption read time. The digital video viewer 200 may format the caption 212 based on an analysis of the frame selection, choosing font, size, and color to provide an optimal presentation in the frame selection. The caption 212 may be divided in to text segments 214, encompassing one or more words in the caption 212. The digital video viewer 200 may apply a text effect 216 to one or more of the text segments 214. A text effect 216 may be changing the font, changing the font size, italicizing, boldfacing, underlining, and other changes to the text segment 214. The digital video viewer 200 may automatically select the text segment 214 to apply the text effect 216 or may allow the user to select the text segment 214 to apply the text effect 216.

The digital video viewer 200 may analyze the frame selection to identify interest areas 218 in the frame selection. An interest area 218 is an area of the frame selection that the user does not want to obscure. For example, an interest area 218 may be a face, a person, a moving object, or other relevant item in the frame selection. The digital video viewer 200 may use motion detection and facial recognition to identify interest areas 218. The digital video viewer 200 may place the emphasis effect or video animation so as to avoid obscuring the interest area 218, such as placing a caption 212 so that the caption 212 does not cover a face.

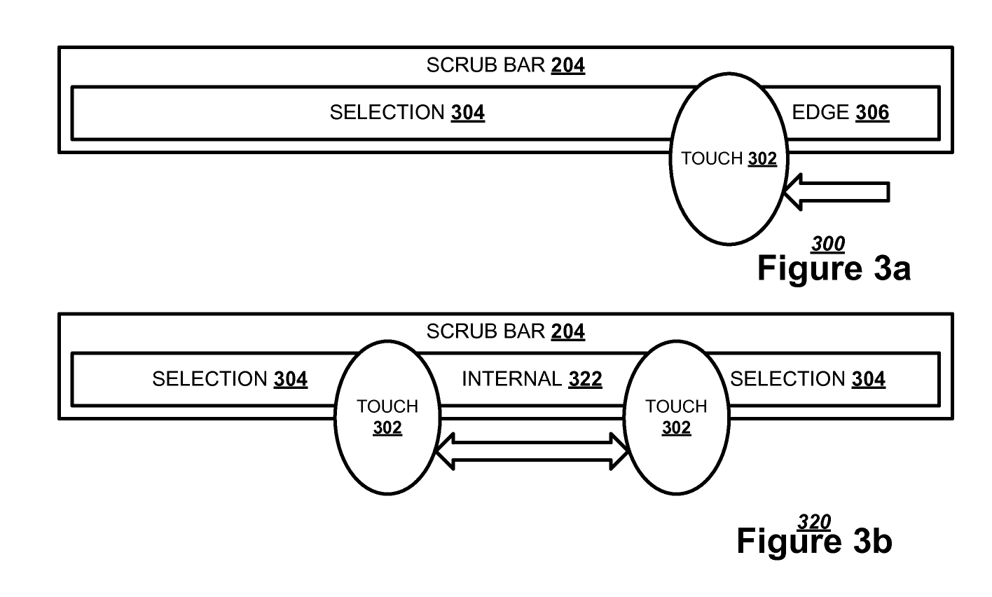

The user may designate sections of the digital video clip through direct manipulation of the scrub bar 204. FIG. 3a illustrates, in a block diagram, one embodiment of a trim action 300 of a digital video clip. The user may apply a touch 302 to the end of the scrub bar 204. The user may then drag that touch 302 inward. The section of the scrub bar 204 that the touch 302 is moving towards is a section selection 304. The remaining section between the touch 302 and the end of the scrub bar is the edge section 306. In a trim action 300, the digital video viewer 200 may remove, or trim, the edge section 306 from the digital video clip. The digital video viewer 200 may then store and play the section selection 304.

FIG. 3b illustrates, in a block diagram, one embodiment of a split action 320 of a digital video clip. The user may apply a first touch 302 and a second touch 302 to the middle of the scrub bar 204. The user may then spread the first touch 302 from the second touch 302. The sections of the scrub bar 204 that the first touch 302 and the second touch 302 are moving towards are section selections 304. The remaining section between the first touch 302 and the second touch 302 is an internal section 322. In a split action 320, the digital video viewer 200 may remove, or excise, the internal section 322 from the digital video clip. The digital video viewer 200 may then store and play the section selection 304 as a single digital video clip.

FIG. 3c illustrates, in a block diagram, one embodiment of an edge move action 340 of a digital video clip. The user may apply a first touch 302 to the middle of a section selection 304 of the scrub bar 204. The user may then move the first touch 302 towards an edge section 306, dragging the section selection 304 to cover some of the edge section 306. The section selection 304 may maintain the same run time as before the edge move action 340. The section selection 304 may keep any edits applied to the section selection 304 while being moved to a different start time in the digital video clip. The digital video viewer 200 may then store and play the section selection 304 with the applied edits intact.

FIG. 3d illustrates, in a block diagram, one embodiment of an internal move action 360 of a digital video clip. The user may apply a first touch 302 to the middle of one of the section selections 304 of the scrub bar 204. The user may then move the first touch 302 towards an internal section 322, dragging the section selection 304 to cover some of the internal section 322. The section selection 304 may maintain the same run time as before the internal move action 360. The section selection 304 may keep any edits applied to the section selection 304 while being moved to a different start time in the digital video clip. The digital video viewer 200 may then store and play the section selection 304 with the applied edits intact.

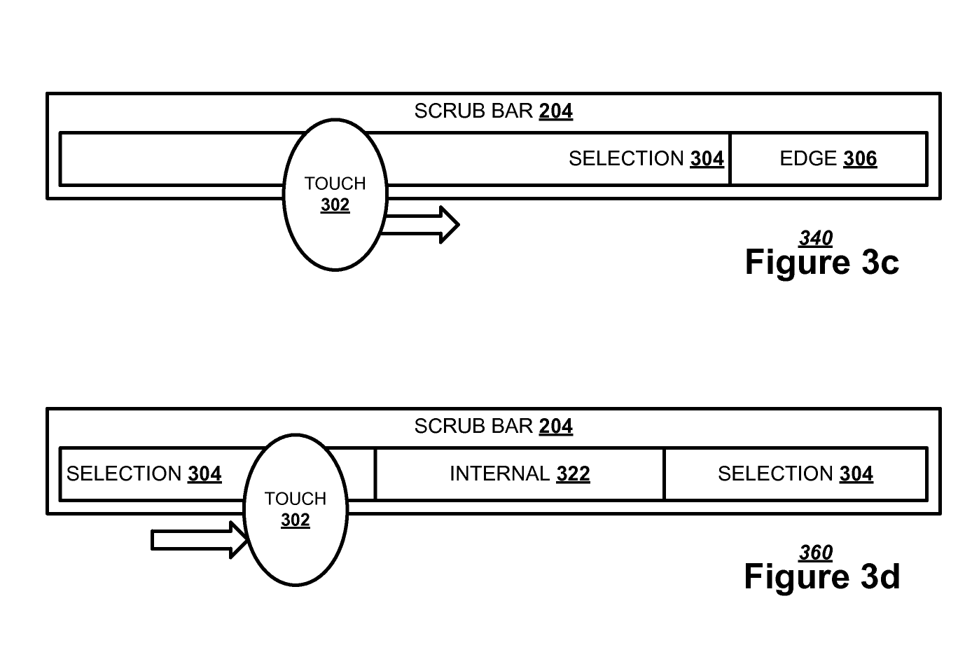

FIG. 4 illustrates, in a block diagram, one embodiment of a video frame input screen 400. The user may enter the video frame input screen 400 using the clip editor control 208. Alternately, the user may enter video edits by selecting coordinates in a video frame 402 while in normal viewing mode. The user may enter user inputs to indicate a frame region to highlight using a touch screen 152, a touch pad 154, a mouse, a gesture recognition device 156, or other coordinate input device. For example, the digital video viewer 200 may separate the video frame 402 into discrete objects. The user may touch 302 a discrete object in the video frame 402 to indicate a focus object 404 the user wants to highlight in the digital video clip. Alternately, the user may create an object outline 406 by dragging a finger around the focus object 404. The user may create an input shape 408 around the frame region by dragging a finger in that shape 408 around the frame region. The video animation may conform to the input shape 408, such as creating rays of color projecting from a circle drawn around a person's head. The user may create a line 410 to indicate a direction vector for a video animation. The direction vector is the direction that a video animation moves.

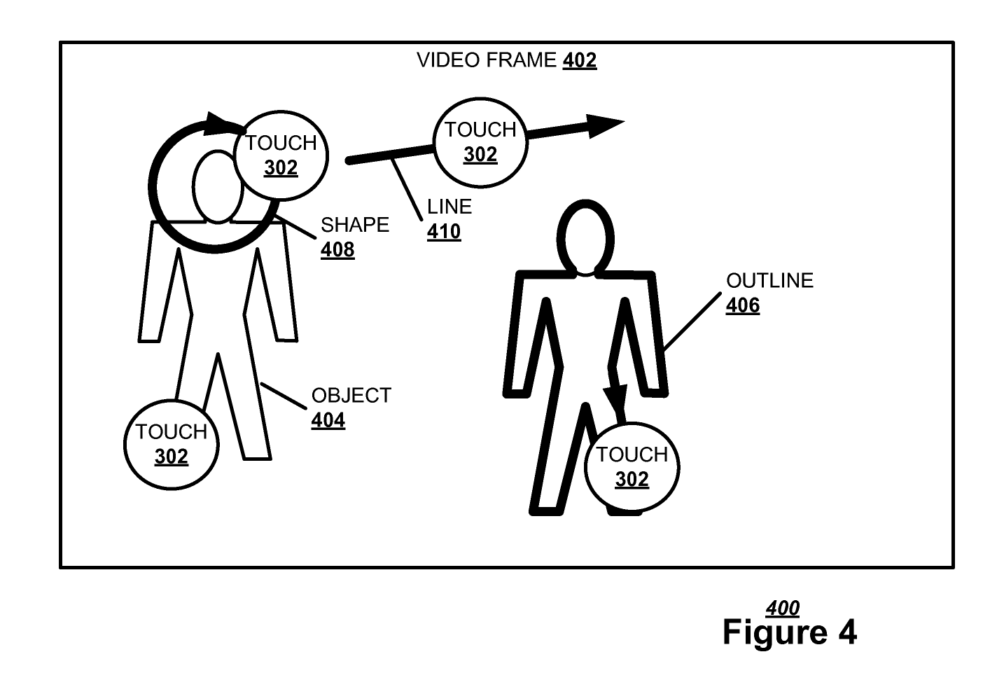

FIG. 5 illustrates, in a block diagram, one embodiment of an animated video frame 500. The digital video viewer 200 may create a video animation 502 around a frame region to highlight the frame region to the viewer. The video animation 502 may be a shape 408, an aura surrounding the frame region, or other moving drawings overlaid on top of the photographic digital image of the animated video frame 500. The frame region may be a focus object 404 in the animated video frame 500, such as a person or item.

The animated video frame 500 may have a frame region indicated by the user and a region background. The region background is the part of the animated video frame 500 that is not in the frame region. The digital video viewer may change the video tint for either the frame region or the region background to highlight the contrast between the two. The video tint may be color, black and white, sepia, or other color variations.

The video animation 502 may move in the direction of an animation direction vector 504. The digital video viewer 200 may set an animation direction vector 504 based on a user input or automatically. The digital video viewer 200 may calculate an automatic animation direction vector 504 partially based on the movement of a focus object 404 or avoidance of any interest areas 218 in the animated video frame 402.

The user may input a caption 212 to be displayed with the video animation 502. The caption 212 may move with the video animation 502. The caption time may be linked to the animation time. The caption time describes the amount of the time in the digital video clip that the caption 212 is displayed. The animation time describes the amount of time in the digital video clip the video animation 502 is displayed. The animation time may be based on an object movement time. The object movement time is the amount of time in the digital video clip the focus object 404 is in motion. Alternately, the caption time and the animation time may be based on the caption read time. The caption read time is the average amount of time for a user to read a caption 212.

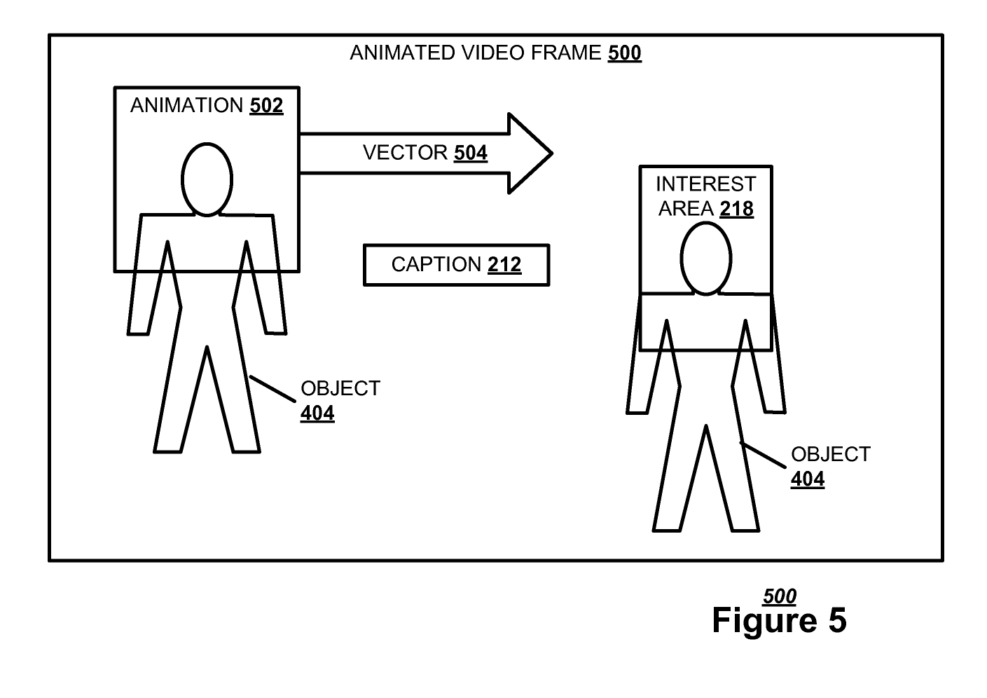

The user may interact with the user interface of the digital video viewer 200 to edit a digital video clip. FIG. 6 illustrates, in a flowchart, one embodiment of a method 600 for receiving editing commands for a digital video clip. The digital video viewer 200 may capture a digital video clip with a digital video camera 180 (Block 602). Alternately, the digital video viewer 200 may download the digital video clip from an external storage device. The digital video viewer 200 may display the digital video clip to a user in a standard viewing mode (Block 604). The digital video viewer 200 may overlay a scrub bar 204 over the digital video clip to receive a user input to move between a predecessor video frame and a successor video frame of the digital video clip by moving a play head 206 in the scrub bar 204 (Block 606). The digital video viewer 200 may tether a clip editor control 208 to the play head 206 to edit the digital video clip (Block 608). The digital video viewer 200 may select a clip edit point based on a play head 206 position within the scrub bar 204 (Block 610). The digital video viewer 200 may edit the digital video clip at a clip edit point based on the play head 206 position (Block 612). The digital video viewer 200 may display a thumbnail preview at a clip edit point with the edits in place (Block 614). If the user changes the play head 206 position within the scrub bar 204 (Block 616), the digital video viewer 200 may move the clip edit point based on a play head 206 change within the scrub bar 204 (Block 618).

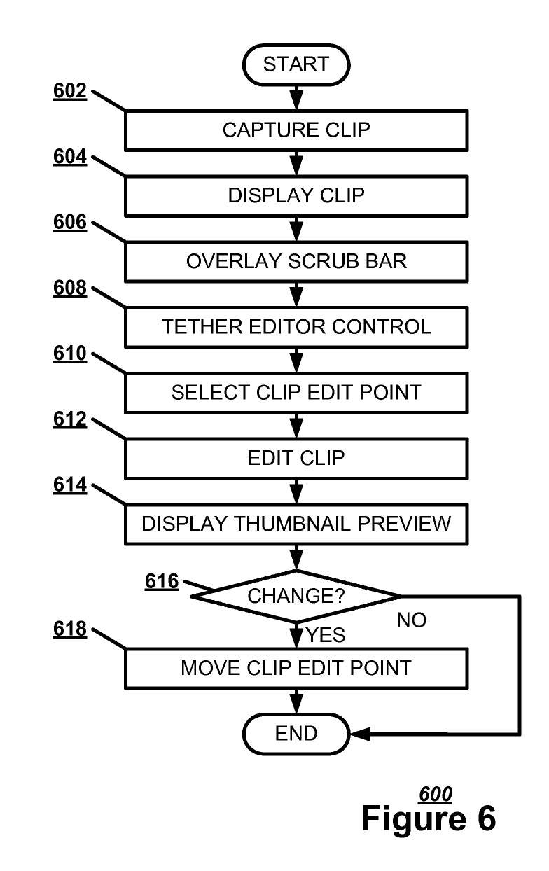

The user may also manipulate the digital video clip directly through the scrub bar 204. FIG. 7 illustrates, in a flowchart, one embodiment of a method 700 for editing a section of a digital video clip. The digital video viewer 200 may detect a user gesture indicating a section selection 304 of the digital video clip (Block 702). The digital video viewer 200 may color-code a section of the digital video clip to indicate a section selection 304 (Block 704). If the user performs a trim gesture on the scrub bar 204 (Block 706), the digital video viewer 200 may trim an edge section 306 from the digital video clip based on a user input (Block 708). If the user performs a split gesture on the scrub bar 204 (Block 710), the digital video viewer 200 may split a section selection 304 within the digital video clip based on a user input (Block 712). The digital video viewer 200 may excise an internal section 322 from the digital video clip based on a user input (Block 714). If the user performs a move gesture on the scrub bar 204 (Block 716), the digital video viewer 200 may move a section selection 304 within the digital video clip based on a user input (Block 718).

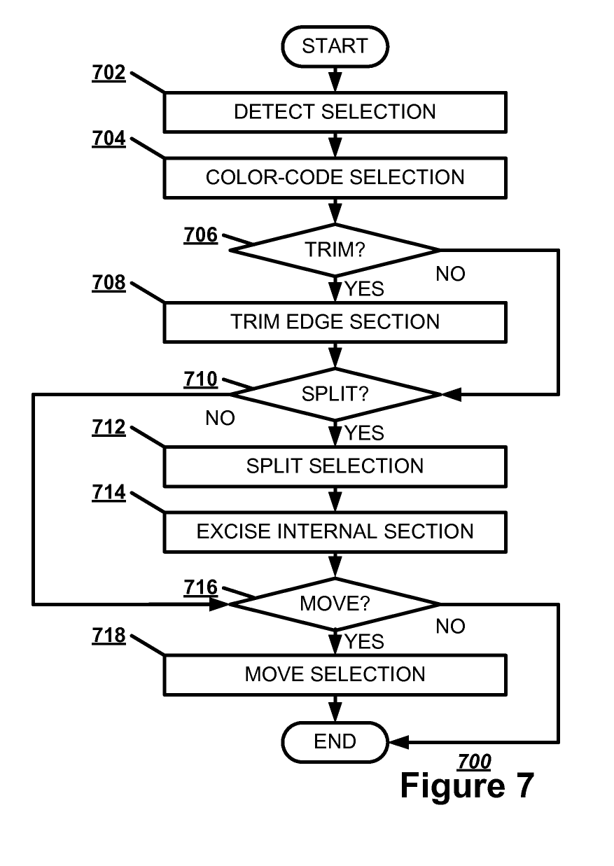

Having selected a section selection 304 or a clip edit point, the user may perform a number of edits the digital video clip. For example, the user may add an audio effect to the digital video clip. FIG. 8 illustrates, in a flowchart, one embodiment of a method 800 for adding an audio effect to a digital video clip. The digital video viewer 200 may mute a clip audio based on a user input at the clip editor control 208 (Block 802). The digital video viewer 200 may add a soundtrack audio based on a user input at the clip editor control 208 (Block 804).

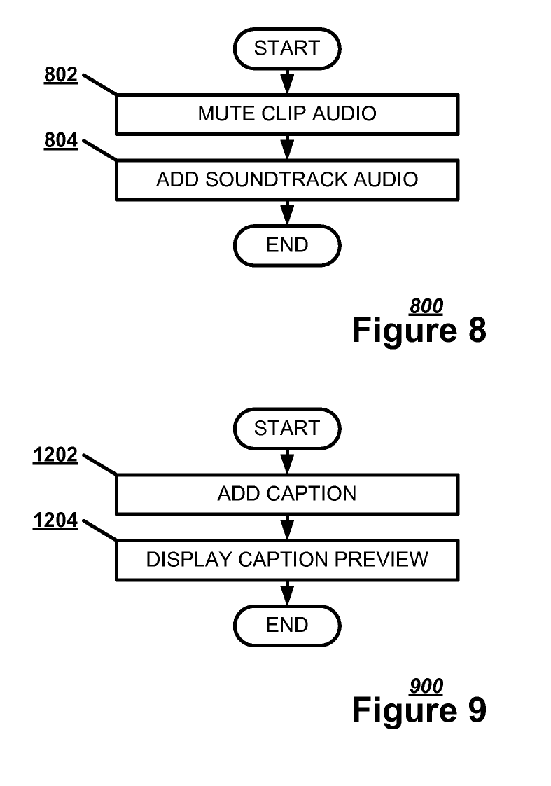

Additionally, the user may add a caption to a digital video clip. FIG. 9 illustrates, in a flowchart, one embodiment of a method 900 for adding a caption to a digital video clip. The digital video viewer 200 may add a caption 212 based on a user input at the clip editor control 208 (Block 902). The digital video viewer 200 may a display a caption 212 preview based on a user input (Block 904).

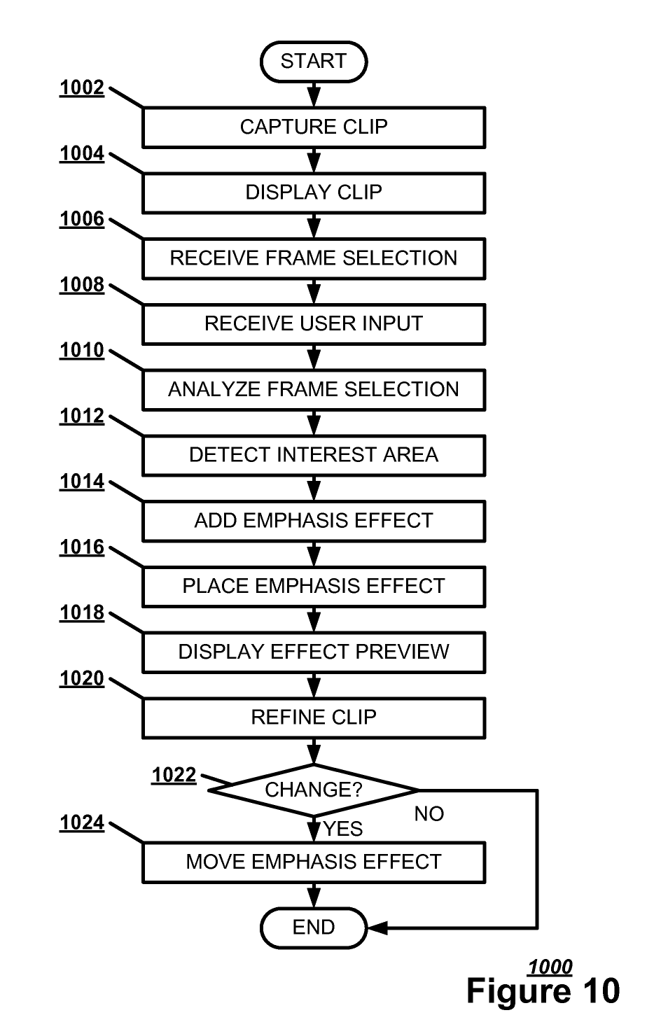

The user may highlight a specific section of the digital video clip by adding an emphasis effect. FIG. 10 illustrates, in a flowchart, one embodiment of a method 1000 for adding an emphasis effect to a frame selection. The digital video viewer 200 may capture a digital video clip with a digital video camera 180 (Block 1002). Alternately, the digital video viewer 200 may download the digital video clip from an external storage device. The digital video viewer 200 may display the digital video clip to a user in a standard viewing mode (Block 1004). The digital video viewer 200 may receive a frame selection from a user (Block 1006). The digital video viewer 200 may receive a user input indicating an emphasis effect (Block 1008).

The digital video viewer 200 may analyze the frame selection (Block 1010). The digital video viewer 200 may automatically detect an interest area in the frame selection (Block 1012). The digital video viewer 200 may automatically add the emphasis effect to the frame selection (Block 1014). The digital video viewer 200 may place the emphasis effect based on the interest area in the frame selection (Block 1016). The digital video viewer 200 may display a thumbnail preview of the frame selection with the emphasis effect added (Block 1018).

The digital video viewer 200 may automatically refine the digital video clip (Block 1020). If the user directs the digital video viewer 200 to change a frame selection for the emphasis effect to a new video frame (Block 1022), the digital video viewer 200 may move the emphasis effect to the new video frame (Block 1024). The user may change the frame selection by moving the play head 206 on the scrub bar 204.

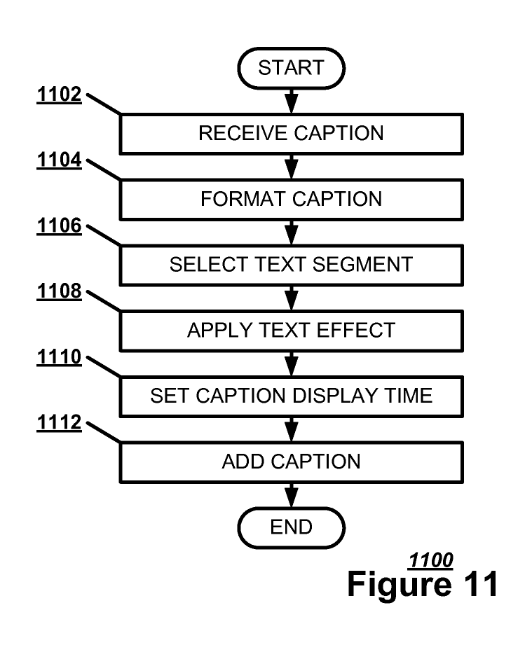

A user may emphasize a section by adding a caption 212. FIG. 11 illustrates, in a flowchart, one embodiment of a method 1100 for adding a caption 212 to a frame selection. The digital video viewer 200 may receive a caption 212 from a user (Block 1102). The digital video viewer 200 may format a caption 212 based on a frame selection analysis (Block 1104). For example, the digital video viewer 200 may select a color for the caption 212 based on the color scheme of the frame selection. The digital video viewer 200 may automatically select a text segment 214 of the caption 212 for a text effect 216 (Block 1106). Alternately, the digital video viewer 200 may create text segment 214 inputs so that the user may select which text segments 214 have a text effect 216 applied. The digital video viewer 200 may apply a text effect 216 to a text segment 214 of the caption 212 (Block 1108). The digital video viewer 200 may set a caption display time based on a caption read time (Block 1110). The digital video viewer 200 may automatically add the caption 212 to the frame selection (Block 1112).

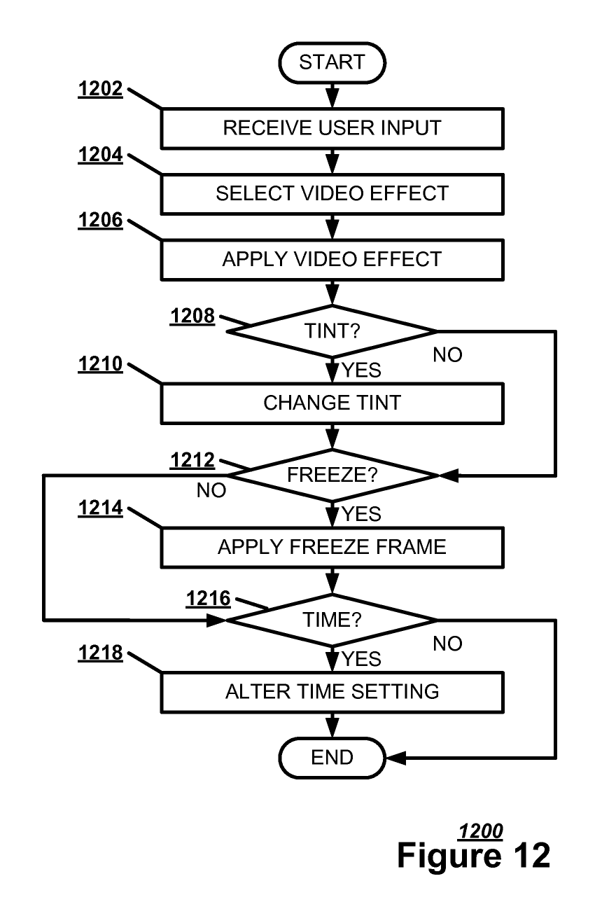

A user may emphasize a section by adding a video effect. FIG. 12 illustrates, in a flowchart, one embodiment of a method 1200 for adding a video effect to a frame selection. The digital video viewer 200 may receive a user input indicating a video effect (Block 1202). The digital video viewer 200 may select a video effect based on a visual theme or a user history (Block 1204). The digital video viewer 200 may apply the video effect to the frame selection (Block 1206). If the user input and visual theme indicate a tint setting effect (Block 1208), the digital video viewer 200 may change the tint setting of the frame selection (Block 1210). If the user input and visual theme indicate a freeze frame effect (Block 1212), the digital video viewer 200 may apply a freeze frame to the frame selection (Block 1214). If the user input and visual theme indicate applying a time setting effect (Block 1216), the digital video viewer 200 may alter the time setting of the frame selection (Block 1218).

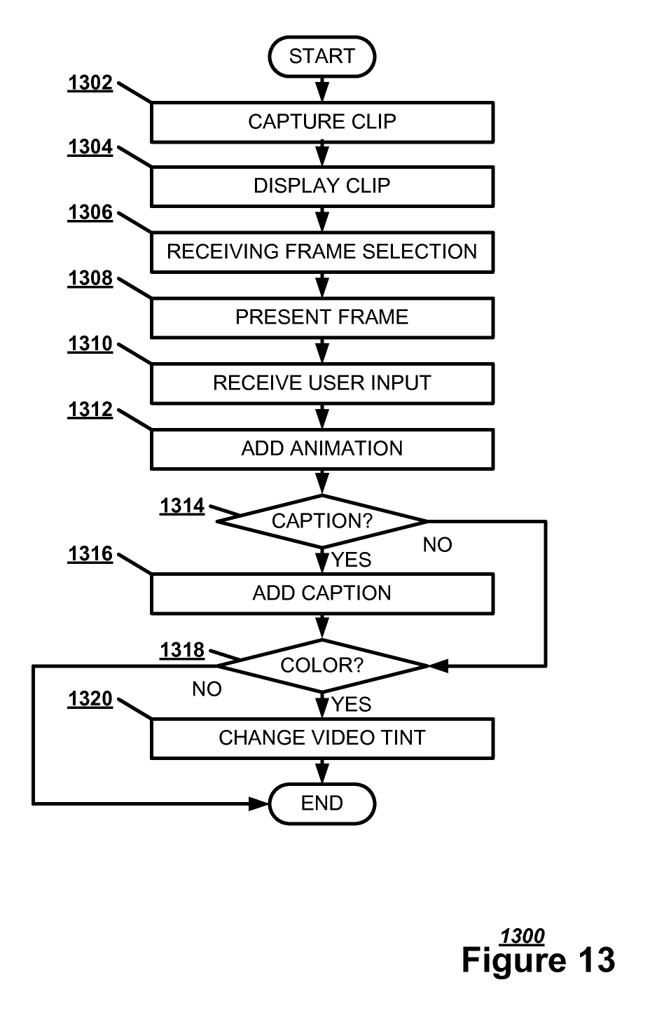

The user may emphasize a specific region of a frame of a digital video clip by adding a frame region highlight. FIG. 13 illustrates, in a flowchart, one embodiment of a method 1300 for adding a frame region highlight. The digital video viewer 200 may capture a digital video clip with a digital video camera 180 (Block 1302). The digital video viewer 200 may display the digital video clip to a user in a standard viewing mode (Block 1304). The digital video viewer 200 may receive a user frame selection from a user indicating a video frame 402 of a digital video clip (Block 1306). The digital video viewer 200 may present the video frame 402 of the digital video clip based on the user frame selection in the standard viewing mode (Block 1308).

The digital video viewer 200 may receive a user input to the video frame 402 indicating a frame region (Block 1310). The digital video viewer 200 may automatically add a video animation 502 to the digital video clip to highlight the frame region (Block 1312). If the user enters a caption 212 for the video frame 402 (Block 1314), the digital video viewer 200 may add a caption to the video frame 402 (Block 1316). If the user directs the digital video viewer 200 to perform a color enhancement (Block 1318), the digital video viewer 200 may change a video tint for at least one of the frame region and a region background (Block 1320).

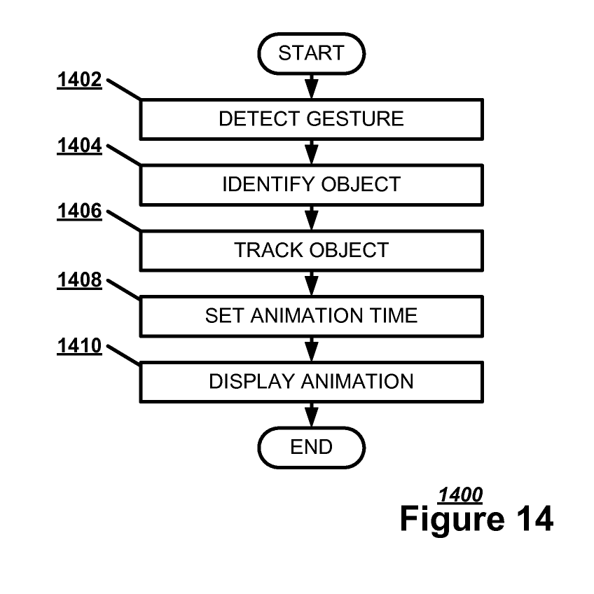

The user may add a video animation 502 to the video frame 402. FIG. 14 illustrates, in a flowchart, one embodiment of a method 1400 for frame region selection. The digital video viewer 200 may detect a gesture by a user indicating at least one of a focus object, a shape, or an object outline (Block 1402). The digital video viewer 200 may identify a focus object in the frame region of the video frame 402 based on the user input (Block 1404). The digital video viewer 200 may track the focus object with the video animation 502 in successive frames (Block 1406). The digital video viewer 200 may set an animation time based on an object movement time (Block 1408). The digital video viewer 200 may display the video animation 502 for the animation time starting with the video frame 402 (Block 1410).

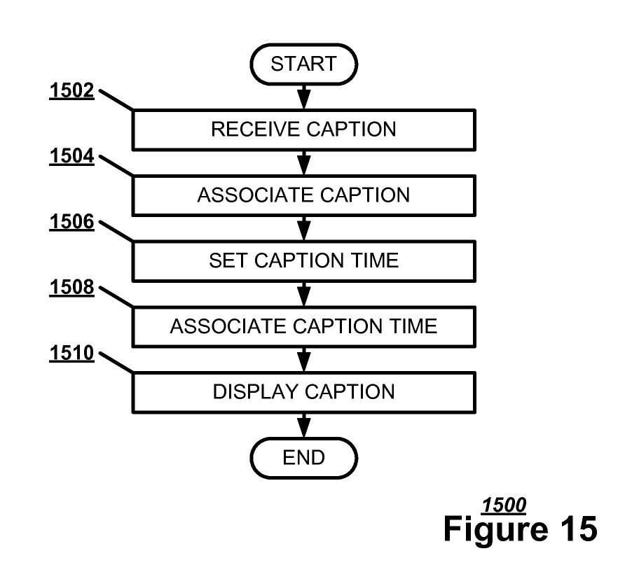

The user may add a caption 212 to the video frame 402. FIG. 15 illustrates, in a flowchart, one embodiment of a method 1500 for captioning. The digital video viewer 200 may receive a caption 212 from the user (Block 1502). The digital video viewer 200 may associate the video animation 502 with a caption 212 for the video frame (Block 1504). The digital video viewer 200 may set a caption time for the caption 212 based on a caption read time (Block 1506). The digital video viewer 200 may associate an animation time for the video animation 502 with a caption time for the caption 212 (Block 1508). The digital video viewer 200 may display the caption for the caption time starting with the video frame 402 (Block 1510).

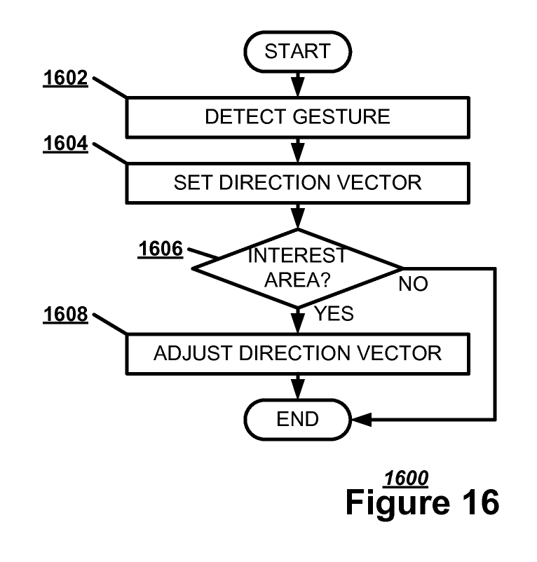

In addition to selecting the frame region, a user may input an animation direction vector 504 for the video animation 502. FIG. 16 illustrates, in a flowchart, one embodiment of a method 1600 for vectoring. The digital video viewer 200 may detect a gesture by a user indicating a line (Block 1602). The digital video viewer 200 may set an animation direction vector 504 based on the user input (Block 1604). If the digital video viewer automatically detects an interest area 218 in the video frame 402 (Block 1606), the digital video viewer may adjust the animation direction vector 504 based on the interest area 218 (Block 1608).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
displaying a digital video clip to a user in a digital video viewer in a standard viewing mode;
receiving in the digital video viewer a frame selection from a user; and
adding automatically an emphasis effect to the frame selection.

2. The method of claim 1, further comprising:
adding automatically a caption to the frame selection.

3. The method of claim 1, further comprising:
applying a video effect to the frame selection.

4. The method of claim 1, further comprising:
receiving a user input indicating a video effect.

5. The method of claim 1, further comprising:
selecting a video effect based on a visual theme.

6. The method of claim 1, further comprising:
changing a tint setting of the frame selection.

7. The method of claim 1, further comprising:
applying a freeze frame to the frame selection.

8. The method of claim 1, further comprising:
altering a time setting of the frame selection.

9. The method of claim 1, further comprising:
detecting automatically an interest area in the frame selection.

10. The method of claim 1, further comprising:
placing the emphasis effect based on an interest area in the frame selection.

11. The method of claim 1, further comprising:
changing a frame selection for the emphasis effect.

12. A tangible machine-readable medium having a set of instructions detailing a method stored thereon that when executed by one or more processors cause the one or more processors to perform the method, the method comprising:
displaying a digital video clip to a user in a digital video viewer in a standard viewing mode;
receiving in the digital video viewer a frame selection from a user; and
adding automatically a caption to the frame selection.

13. The tangible machine-readable medium of claim 12, wherein the method further comprises:
receiving the caption from the user.

14. The tangible machine-readable medium of claim 12, wherein the method further comprises:
setting a caption display time based on a caption read time.

15. The tangible machine-readable medium of claim 12, wherein the method further comprises:
formatting the caption based on a frame selection analysis.

16. The tangible machine-readable medium of claim 12, wherein the method further comprises:
applying a text effect to a text segment of the caption.

17. The tangible machine-readable medium of claim 12, wherein the method further comprises:
selecting automatically a text segment of the caption for a text effect.

18. The tangible machine-readable medium of claim 12, wherein the method further comprises:
applying a video effect to the frame selection.

19. A digital video device, comprising:
a digital video camera that captures a digital video clip;
a display that presents the digital video clip to a user in a digital video viewer in a standard viewing mode;
an input device that receives in the digital video viewer a frame selection from a user; and
digital video processor that adds a caption and a video effect to the frame selection.

20. The digital video device of claim 19, wherein the digital video processor automatically refines the digital video clip.
